(19) United States
(12) Patent Application Publication
(10) Pub. No.: US 2008/0080326 A1
(43) Pub. Date: Apr. 3, 2008

(54) OPTICAL RECORDING METHOD AND APPARATUS

(75) Inventors: Yu-wei Ling, Hsin-Chu City (TW); Yih-shin Weng, Jhubei City (TW)

Correspondence Address: MADSON & AUSTIN, 15 WEST SOUTH TEMPLE, SUITE 900, SALT LAKE CITY, UT, 84101, US

(73) Assignee: Media Tek Inc., Hsin-Chu City (TW)

(21) Appl. No.: 11/536,814

(22) Filed: Sep. 29, 2006

(51) Int. Cl. G11B 21/08

(52) U.S. Cl. 369/30.08

(57) ABSTRACT

An optical recording method and apparatus for recording data to optical recordable medium are present. The optical recording apparatus at least comprises a PUH module and a verifier. The PUH module is used for recording a first number of data units to the optical recordable medium and reading a third number of data units, which are recorded to the optical recordable medium. The verifier is used for verifying the second number of data units being recorded. After the verifier verifies the second number of the data units, the PUH module follows to an initial position to record a third number of data units without any seeking operation. The PUH module keeps recording and reading and the verifier keep verifying until the plurality of data units being recorded and verified.

### FIELD OF THE INVENTION

The present invention generally relates to a method and an apparatus for recording data to an optical recordable medium, and more particularly to a method and an apparatus for seamlessly transiting from a verifying operation to a recording operation in sequence to record data onto the optical recordable medium.

### BACKGROUND OF THE INVENTION

After an optical recording apparatus records data to an optical recordable medium, the optical recording apparatus operates a verifying operation to verify the reliability of data just recorded. When a defect block is found during the verifying operation, the optical recordable medium allocates a replacement for the defect block, and this operation is called a defect management.

Please refer to FIG. 5, a progress diagram showing of the seeking operations, recording operations, the verifying operations, and the corresponding data units in one recording procedure of the data recording method according to prior arts. Between each recording and verifying, the optical recording apparatus has to perform a seeking process to move the pick up head to the desired position. As shown in FIG. 5, there are fifty-two blocks, in one recording procedure. Since the capacity of the memory for buffering the recording data is limited to twenty data units; therefore, one recording procedure for fifty-two data units is divided into three recording sections.

As shown in FIG. 5, Seeking 101 is to seek a target position of the recording procedure. Recording operation 102 is to record twenty data units B0˜B19 to the recordable medium initialed from the target position. Seeking 103 is to seeking the target position of the recorded data. Verifying 104 is to read and verify the twenty data units from target position of the recordable medium. Such as Seeking 101, Recording 102, Seeking 103, and Verifying 104 have to repeat three times for recording fifty-two data units, as Seeking 105, Recording 106, Seeking 107, Verify 108, Seeking 109, Recording 110, Seeking 111, and Verify 112 shown in FIG. 5. Either the seeking operations before the recording operations or the verifying operations are time consuming. Significantly, the seeking operations deeply influence the entire performance of recording data to the recordable medium and the stability of the optical disc drive system in aforesaid alternation and repeated recording-verifying sequences.

Please refer to FIG. 6, showing waveforms of the data transferring, encoding operation, seeking operation, recording operation and the verifying operation according to prior arts. The fifty-two blocks of one recording procedure are divided into three sections, blocks B0˜B19, blocks B20˜B39, and blocks B40˜B51. The data transferring is that the optical recording apparatus receives data from a host. The encoding is that the optical recording apparatus encodes data just received from the host. The recording is to record the encoded data onto the recordable medium. The verifying is to read the data recorded onto the recordable medium and do verify action. As shown in FIG. 6, the conventional optical recording apparatus performs the recording operation after the data units of the first section being totally encoded, so a PUH module in the optical recording apparatus always passed over the target position for recording. The optical recording apparatus has to perform another seeking operation to seek the initial position of the next section, such as seeking operation 105, 109. These seeking operations obviously decrease the entire performance of recording data to the recordable medium.

Correspondingly, there is a need to develop an optical recording method and apparatus, which is capable of seamlessly transiting from a verifying operation to a recording operation to improve the entire performance of recording operation.

### SUMMARY OF THE INVENTION

One aspect of the present invention is to provide an optical recording method for recording a plurality of data units to an optical recordable medium. The optical recording method comprises the following steps. First, recording a first number of data units. Then, verifying a second number of data units being recorded and preparing for recording a third number of data units during the verifying step. Recording a third number of data units successively when finished the verifying step. Finally, repeating the above recording the verifying step until the data units being recorded to the optical recordable medium and verified.

Another aspect of the present invention is to provide an optical recording apparatus, which at least comprises a PUH module and a verifier. The PUH module is used for recording a first number of data units to the optical recordable medium and reading a second number of data units being recorded to the optical recordable medium. The verifier is used for verifying the second number of data units being recorded. After the verifier verifies the second number of the data units, the PUH module follows to an initial position to record a third number of data units and keeps recording and reading until the plurality of data units being recorded and verified.

As mentioned above, the optical recording method and apparatus according to the present invention transits from verifying operation to recording operation seamlessly to provide an efficient recording better than the prior art.

### BRIEF DESCRIPTION OF THE DRAWINGS

The foregoing aspects and many of the attendant advantages of this invention will become more readily appreciated as the same becomes better understood by referencing the following detailed descriptions, when taken in conjunction with the accompanying drawings, wherein:

FIG. 1 illustrates a functional block diagram of an optical recording apparatus for recording data to an optical recordable medium according to the present invention.

FIG. 2 is a progress diagram of seeking operations, recording operations, verifying operations and corresponding data units in one recording procedure according to the present invention.

FIG. 3 shows waveforms of the data transfer operations, encoding operations, seeking operations, recording operations and verifying operations according to the present invention.

FIG. 4 shows a flowchart of the optical recording method according to the present invention.

FIG. 5 is a progress diagram of the seeking operations, recording operations and verifying operations and the corresponding data units in one recording procedure according to prior art.

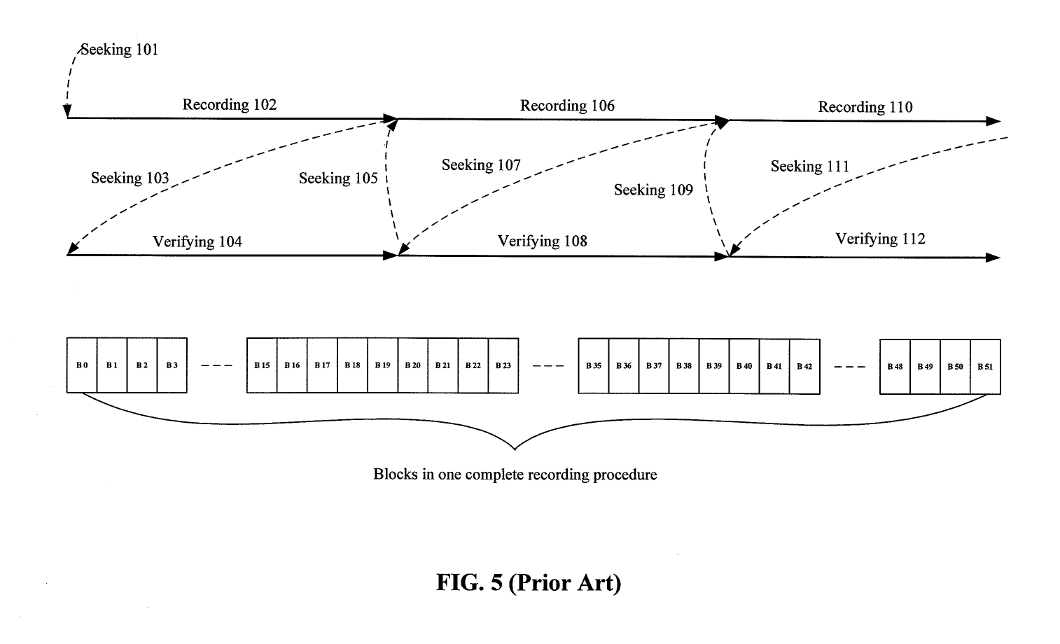

FIG. 6 shows waveforms of the data transfer operations, encoding operations, seeking operation, recording operations and verifying operations according to prior art.

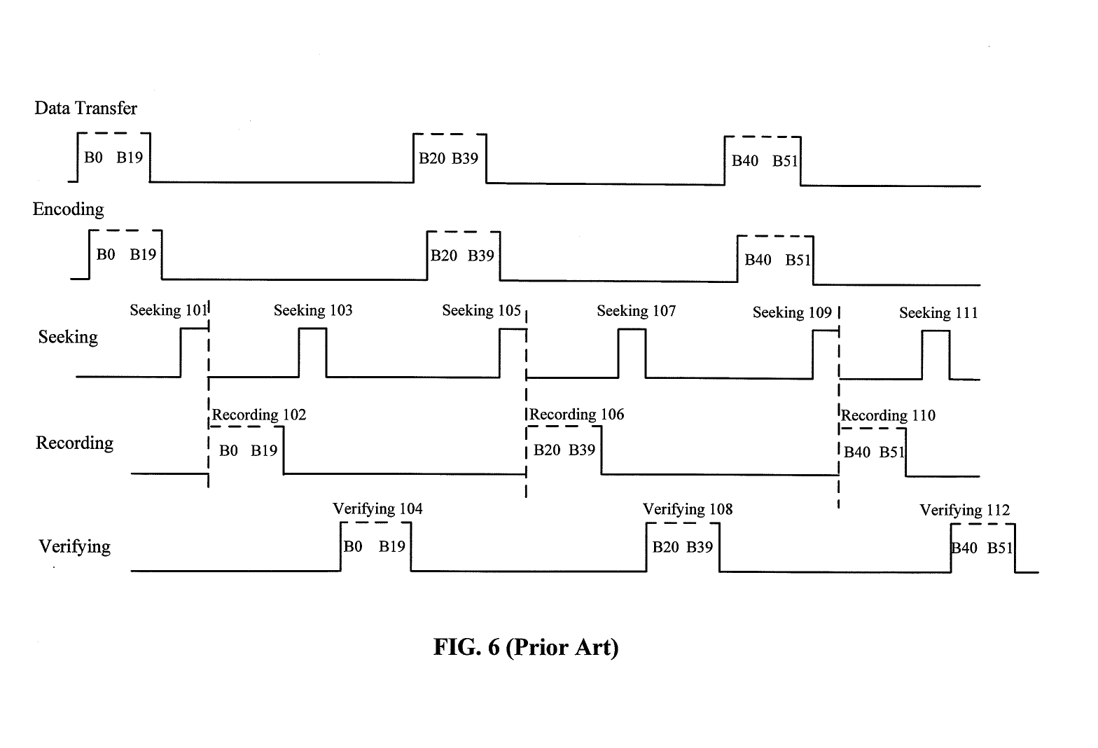

### DETAILED DESCRIPTION OF THE PREFERRED EMBODIMENTS

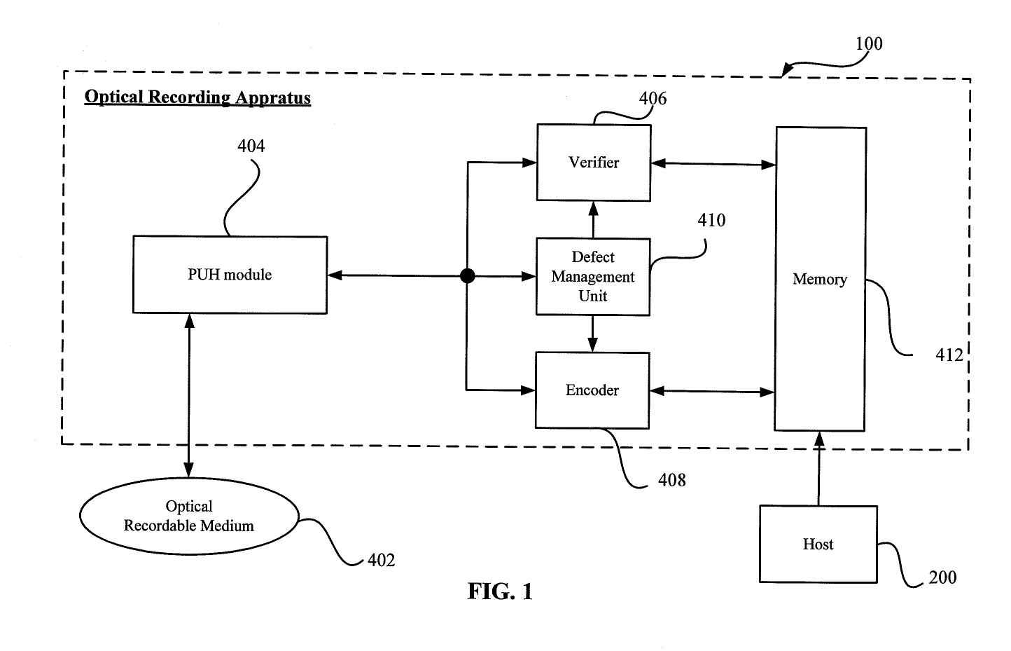

Please refer to FIG. 1, an illustration of a functional block diagram of an optical recording apparatus for recording data to an optical recordable medium 402 according to the present invention. The optical recording apparatus 100 comprises a pick-up head module (PUH module) 404, a verifier 406, an encoder 408, a defect management unit 410, and a memory 412.

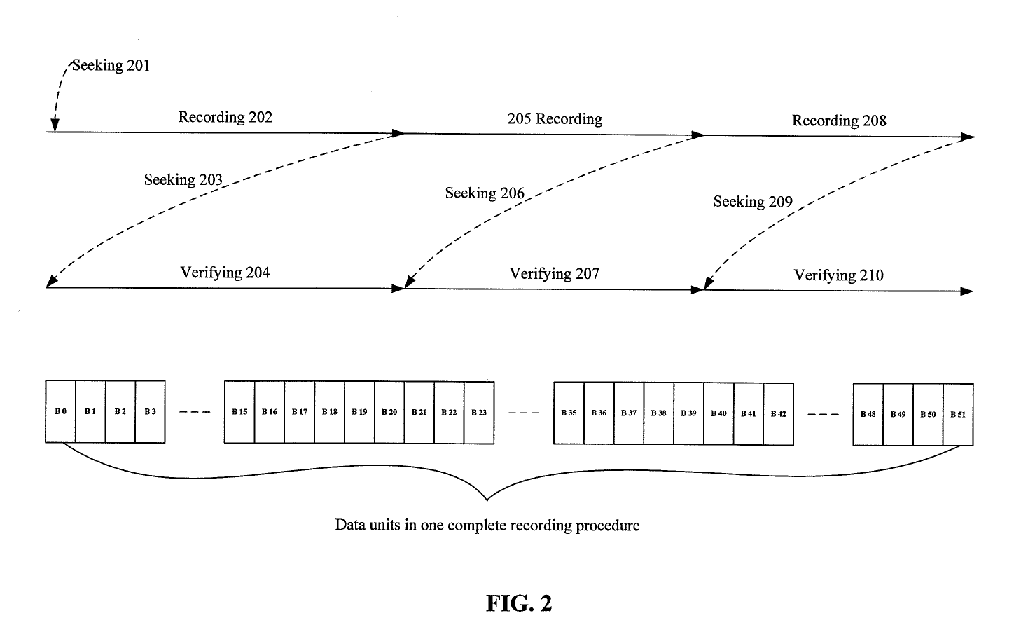

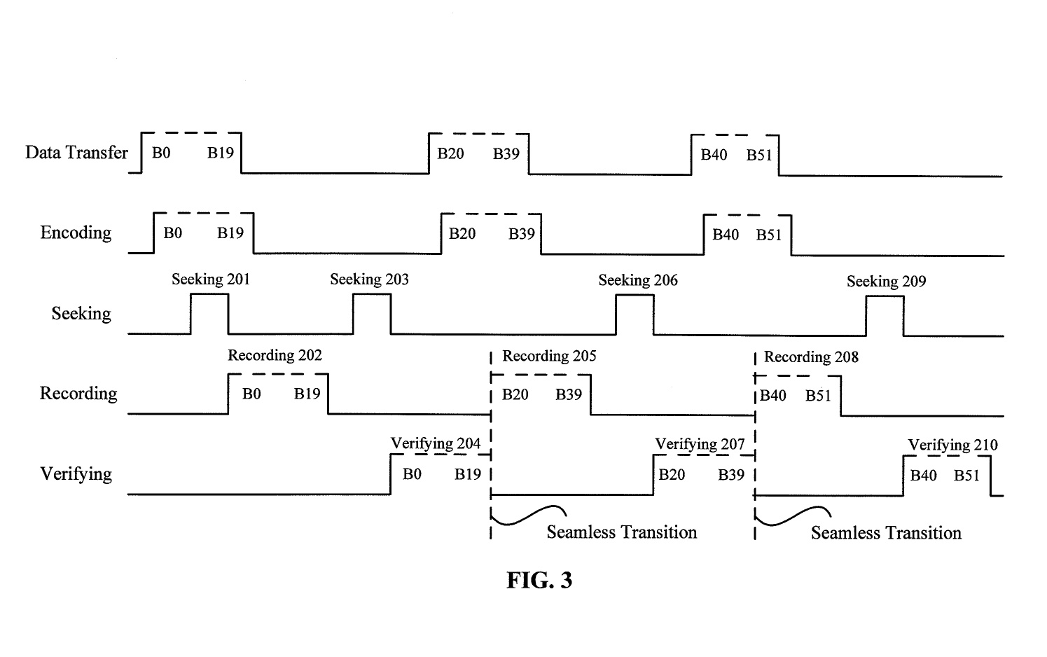

Please also refer to FIG. 2 and FIG. 3. with FIG. 1. FIG. 2 is a progress diagram of seeking operations, recording operations, verifying operations and corresponding data units in one recording procedure according to an embodiment of the present invention. FIG. 3 shows waveforms of the data transfer operations, encoding operations, seeking operations, recording operations and verifying operations according to the embodiment of the present invention. A recording procedure is performed under a command issued by the host 200. Based on the command, the host 200 should transfer the data to the memory 412 through an interface (not shown) between host 200 and the optical recording apparatus 100. The number of data being transferred each time is limited by the capacity of the memory 412. For example, the host 200 commands the optical recording apparatus 100 to record fifty-two data units to the optical recordable medium 402 in a plurality of determined continuation positions of the optical recordable medium 402, and the memory 412 can only buffer twenty data units, so the host 200 should at least transfer the data by three times. The data should be divided to a first section (twenty data units, B0˜B19), a second section (twenty data units, B20˜B39), and a third section (twelve data units, B40˜B51). After the memory 412 has any data from the host for recording, the encoder 408 encodes the data to be data units for recording. The PUH module 404 receives the encoded data units and generating some control signals to control the pick-up head in the PUH module 404. The PUH module 404 makes the pick-up head seek to a target position B0 to generate laser to record the first section of encoded data units B0˜B19 to the optical recordable medium 402. After the recording operation of the first section of data units B0˜B19, the PUH module seeks to the target position B0 and reading back the data units B0˜B19 recorded to the optical recordable medium 402. The PUH module 404 receives the signal representing the recorded data units B0˜B19 reflected from the optical recordable medium and then transfers the recorded data units B0˜B19 to the verifier 406. The PUH module 404 comprises a pick-up head, a signal processing unit, and a servo controller in one embodiment of the present invention for performing the above operations. The verifier 406 verifies recorded data units with the encoded data units buffered in the memory 412. The verifier could be also implemented by a decoder as wild-used by the person skilled in the art.

When the verifier 406 verifies a predetermined number of recorded data units of the first section with the corresponding encoded data units buffered in the memory 412, the memory capacity is released to the host 200 to let the host 200 transfers the second section of data. And when the memory 412 gets the new data from the host 200, the encoder 408 also starts to encode the new coming data for next recording operation. The above processes are performed during the PUH module 404, and the verifier 406 performing the first verifying operation. So when the PUH module 404, and the verifier 406 finish the first verifying operation, the encoder 408 and the memory 412 have prepared enough encoded data units for the PUH module 404 to record to the optical recordable medium 402. According to the present invention, the PUH module 404 follows to a second initial position for recording the second section of data units without another seeking operation between the first verifying operation and the second recording operation. On the other hand, according to the present invention, the hardware latency between the read mode and the write mode transition can be eliminated. After the optical recording apparatus verifies the last data block of the first section, the optical recording apparatus could immediately records the first data block of the second section and without performing any seeking operation, i.e. the PUH module 404 controls the pick-up head to perform a normal following operation from the last data block of the first section to the first data block of the second section continuously. The hardware in the optical recording apparatus could be operated simultaneously; the hardware used for recording could prepare data for recording when the hardware for verifying are used to verify data.

As aforementioned, the hardware of the optical recording apparatus according to prior art can only implement one operation at one time, that is, decoding or encoding, seeking, recording, verifying, or defect managing. Meanwhile, it is necessary to execute the seeking operation between the finished verifying operation and the upcoming recording operations in the prior art. The hardware latency (post-process of verifying operation 104 and pre-process of the recording operation 106) cannot be avoided. However, by having aforesaid ability of bi-directional data processing, the processing of the recorded data to be verified in the verifying operations and the processing of the recording data to be written in the recording operations can be executed at the same time. The apparatus of the present invention can prepare the data to be recorded for next recording operation during the time of verifying operation by encoding the data to be recorded and buffering them in the memory 412. Accordingly, seamlessly transiting from a verifying operation to a recording operation can be achieved.

Please refer to FIGS. 2 and 3; there are 52 data units, for example, in one recording procedure. Since the capacity of the memory 412 is limited, one recording procedure may need to be finished by several recording-operations, such as the data units B0˜B19, the data units B20˜B39, and the data units B40˜B51. First, the apparatus of the present invention executes Seeking 201 for seeking the target position for Recording 202, and then executes the Recording 202. After the Recording 202 is finished, the apparatus of the present invention executes Seeking 203 for seeking the initial position for Verifying 204, and then executes the Verifying 204. During the time of Verifying 204, the apparatus of the present invention prepares for the Recording 205 by receiving the data transferred from the host and encoding the data to be recorded in advance. Besides, maybe also perform some defect management or any other operation has to be prepared. Said these processes that has to be prepared before recording could be name prepare processes. After the Verifying 204 is finished, the apparatus of the present invention can execute the Recording 205 instantaneously (without any delay) since the data to be recorded was ready.

After the Recording 205 is finished, the apparatus of the present invention executes Seeking 206 for seeking the initial position for Verifying 207, and then executes the Verifying 207. During the time of Verifying 207, the apparatus of the present invention prepares for the Recording 208 as described above. After the Verifying 207 is finished, the apparatus of the present invention executes the Recording 208 instantaneously (without any delay) since the data to be recorded was ready. After the Recording 208 is finished, the apparatus of the present invention executes Seeking 209 for seeking the initial position for Verifying 210, and then executes the Verifying 210. Finally, the one recording procedure for fifty-two data units is completed.

According to the present invention, seamlessly transiting from Verifying 204 to Recording 205 and seamlessly transiting from Verifying 207 to Recording 208 to improve the entire performance of recording data to the optical recordable medium can be achieved. Furthermore, the number of data units recorded in each recording operation is flexible and variable in the present invention to provide efficient flexibility for many possible defects or physical segments which existed on the optical recordable medium. For example, if the aforesaid PUH module obtains the information that one recording procedure is across a boundary of a physical segment, the data unit number of the recording operations can be changed to avoid crossing the boundary of the physical segment for preventing possible error caused by the boundary between two physical segments. In addition, the defect management unit 410 can terminate the Recording 205 when a defect data unit is found in the verified data units of the Verifying 204 in replacing the data of the defect data unit. Similarly, the defect management unit 410 terminates the Recording 208 when a defect is found in the verified data units of the Verifying 207 in replacing the data of the defect. Alternatively, the defect management unit 410 provides a defect mark for the defect when the defect is found in Verifying 204 and 207 and replaces the data of the defect after finishing one recording procedure.

As mentioned above, the number of data units recorded in each recording operation is flexible and variable in the present invention to provide efficient flexibility for recording procedure. In one embodiment, the host 200, the memory 412, the encoder 408 prepare a first number of data units for recording, after recording, the verifier can just verify a second number of data units that just recorded to the optical recordable medium 402. The first number and the second number can be the same or different integers, but the second number should be less or equal to the first number. During verifying operation, the host 200, the memory 412, the encoder 408 can prepare a third number of data units for next recording. The first number and third number can be the same or different integers, but should be both limited to the memory capacity.

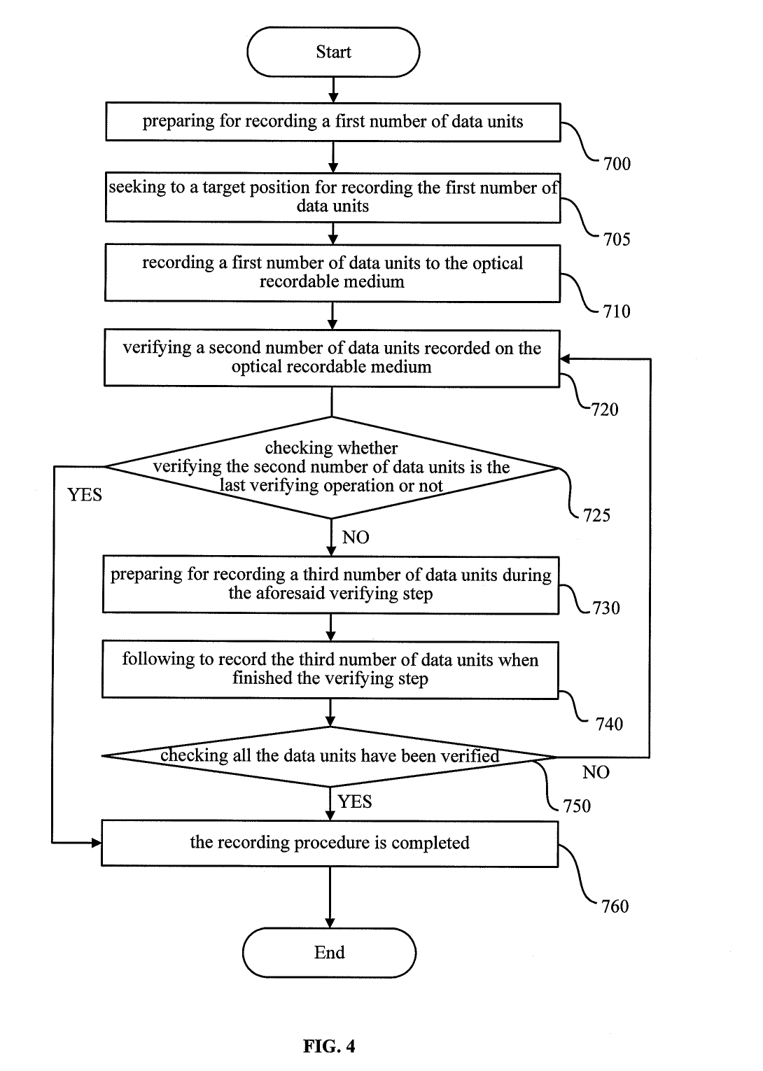

Please refer to FIG. 4. It shows a flowchart of the optical recording method for recording data to the optical recordable medium. The method comprises:

Step 700, preparing for recording a first number of data units;

Step 705, seeking to a target position for recording the first number of data units;

Step 710, recording a first number of data units to the optical recordable medium 402;

Step 720, verifying a second number of data units recorded on the optical recordable medium 402;

Step 725, checking whether verifying the second number of data units is the last verifying operation or not; if yes, go to step 760; if no, go to step 730;

Step 730, preparing for recording a third number of data units during the aforesaid verifying step;

Step 740, following to record the third number of data units when finished the verifying step;

Step 750, checking all the data units have been verified; if yes, go to step 760, if no, go to step 720.

Step 760, the recording procedure is completed.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

What is claimed is:

1. A method of recording a plurality of data units to an optical recordable medium, the method comprising:
recording a first number of data units to the optical recordable medium;
verifying a second number of data units being recorded;
preparing for recording a third number of data units during the verifying step;
recording the third number of data units when finishing the verifying step; and
repeating the above steps until the plurality of data units being recorded and verified.

2. The method of claim 1, wherein the first number, second number, and the third number are positive integers.

3. The method of claim 1, wherein both the first number and the third number of the data units are limited by a memory capacity.

4. The method of claim 1, wherein the preparing step comprises encoding the third number of data units.

5. The method of claim 1, wherein the preparing step comprises receiving the third number of data units from a host.

6. The method of claim 1, wherein the recording steps are initiated at a following position after the verifying step.

7. The method of claim 1, further comprising a step of following to an initial position of a third number of recordable units on the optical recordable medium to record the third number of data units after the verifying step without seeking.

8. A method of recording a plurality of data units to an optical recordable medium, the method comprising:
recording a first number of data units to the optical recordable medium;
verifying a second number of data units being recorded on the optical recordable medium; and
following to an initial position of a third number of recordable units to record the third number of data units after verifying the second number of data unit being recorded on the optical recordable medium.

9. The method of claim 8, wherein the first number, the second number, and the third number are positive integers.

10. The method of claim 8, wherein the first number and the second number of the data units are limited by a memory capacity.

11. The method of claim 8, further comprising a step of preparing for recording the third number of data units between the verifying and recording steps.

12. The method of claim 8, wherein the following step changes from a verifying operation to a recording operation immediately.

13. The method of claim 8, wherein the following step is following from a last position for last verifying to a initial position for next recording and these two position are continuous positions in the optical recordable medium.

14. The method of claim 8, wherein the step of following to the initial position is without seeking.

15. An optical recording apparatus for recording a plurality of data units to an optical recordable medium, the apparatus comprising:
a pick-up head module (PUH module), recording a first number of data units to the optical recordable medium and reading a second number of data unit being recorded from the optical recordable medium; and
a verifier coupled to the PUH module, verifying the second number of data units being recorded;
wherein after the verifier verifies the second number of the data units, the PUH module follows to an initial position to record a third number of data units and keeps recording and reading until the plurality of data units being recorded and verified.

16. The apparatus of claim 15, wherein the first number, the second number, and the third number are positive integers.

17. The apparatus of claim 15, wherein both the first number and the third number of the data units are limited by a memory capacity.

18. The apparatus of claim 15, further comprising an encoder encodes the third number of data units for recording between the verifier finished verifying the second number of data units and the pick-up head starts to record the third number of the encoded data units.

19. The apparatus of claim 15, wherein the pick-up head follows to the initial position without seeking.
